(19) United States
(12) Patent Application Publication
(10) Pub. No.: US 2021/0278888 A1
(43) Pub. Date: Sep. 9, 2021

(54) Information Processing System And Information Processing Apparatus

(71) Applicant: Fujitsu Client Computing Limited, Kawasaki-Shi (JP)

(72) Inventors: Tatsuya SHIMURA, Kawasaki (JP); Hiromi KOIZUMI, Kawasaki (JP)

(21) Appl. No.: 17/189,311

(22) Filed: Mar. 2, 2021

(30) Foreign Application Priority Data
Mar. 6, 2020 (JP) 2020-038305

(51) Int. Cl. G06F 1/26

(52) U.S. Cl. CPC G06F 1/26; G06F 9/4406

(57) ABSTRACT

An information processing apparatus has a first processor, a memory, and a second processor. The memory and second processor are supplied with power from a power supply by a first supplying operation. The first processor is supplied with power from the power supply by a second supplying operation that starts when a startup instruction is inputted during the first supplying operation, executes a series of processes that precedes booting of an operating system, and that outputs a code indicating an execution step in the series of processes to the memory. The second processor outputs the code stored in the memory from an output port at least while the first supplying operation is being performed before inputting of a startup instruction. The debug board has a display unit and a third processor. The third processor receives the code from the output port and displays code-based information on the display unit.

### CROSS-REFERENCE TO RELATED APPLICATION

This application is based upon and claims the benefit of priority of the prior Japanese Patent Application No. 2020-038305, filed on Mar. 6, 2020, the entire contents of which are incorporated herein by reference.

### FIELD

The embodiments discussed herein are related to an information processing system and an information processing apparatus.

### BACKGROUND

Some computers execute a BIOS (Basic Input Output System) at startup. By executing a BIOS, a computer may diagnose whether an abnormality has occurred for any device in the computer itself or a peripheral connected to the computer before the OS (Operating System) is booted. This diagnosing of devices and peripherals is sometimes referred to as a “POST” (Power On Self Test).

As an example technology related to POST, an information processing apparatus capable of speeding up the processing of a program that detects a failure in an apparatus at startup and of raising the probability that failures in the apparatus will be discovered has been proposed.

See, for example, Japanese Laid-open Patent Publication No. 2017-122997.

During a POST, the respective parts of the computer are diagnosed in order, and POST codes corresponding to the respective diagnoses are outputted. By checking the POST codes, the user may identify where an abnormality has occurred in the computer.

One conceivable configuration is to have the user check POST codes that are outputted via a display or an output port set in advance by the BIOS. However, when the computer shuts down during execution of the POST, POST codes will not be outputted via the display or the output port set by the BIOS. In that situation, the computer is incapable of notifying the user of where an abnormality has occurred.

### SUMMARY

According to an aspect, there is provided an information processing system including: an information processing apparatus including a memory that is supplied with electrical power from a power supply by a first power supplying operation, a first processor that is supplied with electrical power from the power supply by a second power supplying operation that is started in response to inputting of a startup instruction during execution of the first power supplying operation, that executes a series of processes that precedes booting of an operating system, and that outputs a code indicating an execution step in the series of processes to the memory, and a second processor that is supplied with electrical power from the power supply by the first power supplying operation and is capable of outputting the code stored in the memory from an external output port at least while the first power supplying operation is being performed before the inputting of the startup instruction; and a debug board including a display unit and a third processor that receives the code from the external output port and displays information based on the code on the display unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts an example of an information processing system according to a first embodiment;

FIG. 2 depicts one example of an information processing system according to a second embodiment;

FIG. 3 depicts an example hardware configuration of a user terminal;

FIG. 4 depicts an example hardware configuration of a debug board;

FIG. 5 depicts an example of a connector;

FIG. 6 is a block diagram depicting example functions of a user terminal and a debug board;

FIG. 7 depicts an example of data transmitted and received between a user terminal and a debug board;

FIG. 8 depicts an example method of transmitting a POST code from a user terminal to a debug board;

FIG. 9 is a flowchart depicting an example procedure of a startup process;

FIG. 10 is a flowchart depicting an example procedure of a POST code displaying process during TYPE-C connection establishment; and

FIG. 11 is a flowchart depicting an example procedure of a POST code displaying process with connecting TYPE-C.

### DESCRIPTION OF EMBODIMENTS

Several embodiments will be described below with reference to the accompanying drawings. Note that when feasible, it is possible to implement a plurality of the following embodiments in combination.

### First Embodiment

First, a first embodiment will be described.

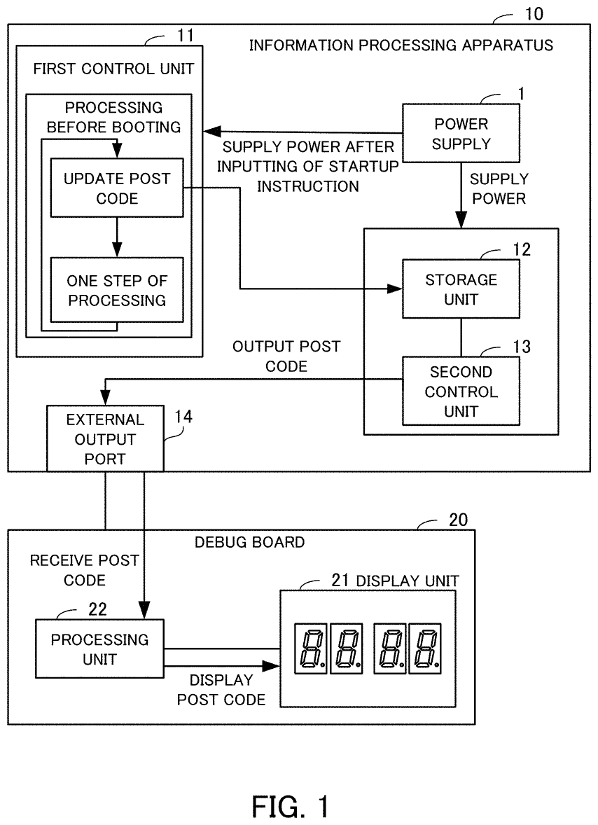

FIG. 1 depicts an example of an information processing system according to the first embodiment. In this first embodiment, a code indicating an execution step in a series of processes performed by an information processing apparatus 10 before booting the OS is displayed on the debug board 20. In this example, the information processing apparatus 10 is a computer operated by the user. The information processing apparatus 10 is supplied with electrical power from a power supply 1. The power supply 1 may be located inside or outside the information processing apparatus 10. As examples, the power supply 1 may be a battery of the information processing apparatus 10 or may be commercial power.

The information processing apparatus 10 includes a first control unit 11, a storage unit 12, a second control unit 13, and an external output port 14. The storage unit 12 and the second control unit 13 are supplied with electrical power from the power supply 1. This will be referred to as a “first power supplying operation”. The first control unit 11 is supplied with electrical power from the power supply 1 by a “second power supplying operation” that starts in response to inputting of a startup instruction while the first power supplying operation is being performed. This inputting of a startup instruction is an input operation for starting up the information processing apparatus 10. As one example, the inputting of a startup instruction is the user pressing a power switch of the information processing apparatus 10. In this way, the power supply 1 supplies power to the storage unit 12 and the second control unit 13 regardless of whether a startup instruction has been inputted, and supplies power to the first control unit 11 after inputting of a startup instruction.

The first control unit 11 controls the information processing apparatus 10 and is capable of executing needed processing. As examples, the first control unit 11 is a processor or a computational circuit included in the information processing apparatus 10. The first control unit 11 executes a series of processes that precedes booting of the operating system (OS). As one example, this series of processes that precedes booting of the OS is a power-on self-test (POST).

The first control unit 11 outputs a code indicating an execution step in the series of processes that precedes booting of the OS to the storage unit 12. As one example, this code indicating the execution step in the series of processes that precedes booting of the OS is a POST code. As one example, when the first control unit 11 executes the processing of a single step in the series of processes that precedes booting of the OS, the POST code stored in the storage unit 12 is updated to a POST code corresponding to that processing step to be executed.

The storage unit 12 is a storage region for storing a POST code outputted from the first control unit 11. As one example, the storage unit 12 is a buffer included in a microcomputer that controls the supplying of electrical power from the power supply 1 to the information processing apparatus 10. The second control unit 13 is capable of operating even when the first control unit 11 has not started up, and executes part of the control processing of the information processing apparatus 10. As one example, the second control unit 13 is a processor or a computational circuit included in a microcomputer that controls the supplying of electrical power from the power supply 1 to the information processing apparatus 10.

The second control unit 13 is capable of outputting the POST code stored in the storage unit 12 from the external output port 14, at least while the first power supplying operation is being performed before a startup instruction is inputted. Note that the second control unit 13 may also be capable of outputting the POST code stored in the storage unit 12 from the external output port 14 while the first power supplying operation is being performed but after inputting of the startup instruction.

The external output port 14 is a port capable of externally outputting data regardless of whether a startup instruction has been inputted. As one example, the external output port 14 is a USB (Universal Serial Bus) Type-C connector. The external output port 14 includes a power supply line and a control line. The power supply line is provided to supply electrical power from the power supply 1 to the debug board 20 while the first power supplying operation is being performed. This means that the power supply 1 is capable of supplying electrical power to the debug board 20 via the power supply line regardless of whether a startup instruction has been inputted. Data for controlling the supplying of power from the power supply 1 to the debug board 20 is outputted from the control line. The second control unit 13 is capable of outputting the POST code stored in the storage unit 12 from the control line.

The debug board 20 has a display unit 21 and a processing unit 22. The display unit 21 is a device for displaying a POST code. As one example, the display unit 21 is a plurality of 7-segment LEDs (Light Emitting Diodes). The processing unit 22 controls the debug board 20. As one example, the processing unit 22 is a processor or a computational circuit in a microcomputer. The processing unit 22 receives a POST code from the external output port 14. The processing unit 22 then has information based on the received POST code displayed on the display unit 21. As one example, the processing unit 22 displays the received POST code in hexadecimal on the display unit 21.

As one example, as described below, the display unit 21 displays a POST code when the information processing apparatus 10 and the debug board 20 are connected. When the information processing apparatus 10 and the debug board 20 are connected via the external output port 14, the processing unit 22 transmits information indicating that the information processing apparatus 10 and the debug board have been connected to the information processing apparatus 10. On receiving the information indicating that the information processing apparatus 10 and the debug board 20 have been connected, the second control unit 13 outputs the POST code stored in the storage unit 12 from the external output port 14. The processing unit 22 then receives the POST code from the external output port 14 and displays information based on the received POST code on the display unit 21.

As another example, as described below, the display unit 21 displays the POST code in real time while the first control unit 11 is executing the series of processes that precedes booting of the OS. When the POST code stored in the storage unit 12 is updated during execution of the series of processes that precedes booting of the OS by the first control unit 11, the second control unit 13 outputs the updated POST code stored in the storage unit 12 from the external output port 14. The processing unit 22 then receives the POST code and displays information based on the received POST code on the display unit 21.

With the information processing system according to the first embodiment, the first control unit 11, which is supplied with electrical power from the power supply 1 in response to the inputting of a startup instruction during execution of the first power supplying operation, executes the series of processes that precedes booting of the OS and outputs a POST code indicating an execution step in the series of processes to the storage unit 12. The second control unit 13, which is supplied with electrical power from the power supply 1 by the first power supplying operation, is capable of outputting the POST code stored in the storage unit 12 from the external output port 14 at least while the first power supplying operation is being performed before a startup instruction is inputted. The processing unit 22 then receives the POST code from the external output port 14 and displays information based on the POST code on the display unit 21. By doing so, the information processing system according to the first embodiment enables the user to check a POST code indicating the execution step in the series of processes that precedes booting of the OS, even when the first control unit 11 has not started up. By doing so, the information processing system according to the first embodiment makes it easy to notify the user of abnormalities.

The external output port 14 includes a power supply line for supplying electrical power from the power supply 1 to the debug board 20 while the first power supplying operation is being performed and a control line on which data for controlling the supplying of electrical power from the power supply 1 to the debug board 20 is outputted. The second control unit 13 is capable of outputting the POST code stored in the storage unit 12 from the control line. Since a POST code is transmitted in this way from the control line for supplying power, the information processing apparatus 10 may easily transmit a POST code to the debug board 20 with a reduced number of components.

When the information processing apparatus 10 and the debug board 20 have been connected via the external output port 14, the processing unit 22 transmits information indicating that the information processing apparatus 10 and the debug board 20 have been connected to the information processing apparatus 10. On receiving the information indicating that the information processing apparatus 10 and the debug board 20 have been connected, the second control unit 13 outputs the POST code stored in the storage unit 12 from the external output port 14. By doing so, in the information processing system according to the first embodiment, by connecting the information processing apparatus 10 and the debug board 20, it becomes possible for the user to check a POST code indicating the execution step in the series of processes that precedes booting of the OS.

It is also possible for the second control unit 13 to output the POST code stored in the storage unit 12 from the external output port 14 while the first power supplying operation is being performed but after the inputting of a startup instruction. With this configuration, even when the first control unit 11 has started up, it is still possible to enable the user to check a POST code indicating an execution step in the series of processes that precedes booting of the OS.

Also, when the first control unit 11 executes the processing in a single step in the series of processes that precedes booting of the OS, the POST code stored in the storage unit 12 is updated to a POST code corresponding to that step. In response, the second control unit 13 outputs the POST code stored in the storage unit 12 from the external output port 14. By doing so, the information processing system according to the first embodiment is capable of notifying the user in real time of the occurrence of an abnormality during the execution of the series of processes that precedes booting of the OS.

### Second Embodiment

Next, a second embodiment will be described. In this second embodiment, a user terminal executes a POST and displays a POST code on a debug board. The POST is processing executed before a computer boots the OS, and as examples includes verification of whether a device such as memory is normal, detection of devices, and initialization of devices. POST codes are expressed by two hexadecimal digits, for example, and correspond to the respective processes included in the POST. The POST is one example of the series of processes that precedes booting of the OS described in the first embodiment, and the POST code is one example of a code indicating an execution step in the series of processes described in the first embodiment.

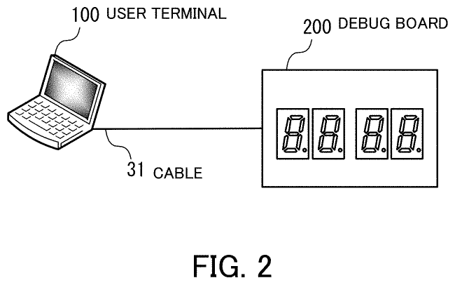

FIG. 2 depicts one example of an information processing system according to the second embodiment. The information processing system according to the second embodiment includes a user terminal 100 and a debug board 200. The user terminal 100 and the debug board 200 are connected via a cable 31. The cable 31 is a USB Type-C cable.

The user terminal 100 is a computer operated by the user. The user terminal 100 executes the POST at startup. The user terminal 100 transmits a POST code to the debug board 200. The debug board 200 displays the POST code received from the user terminal 100 on one or more 7-segment LEDs.

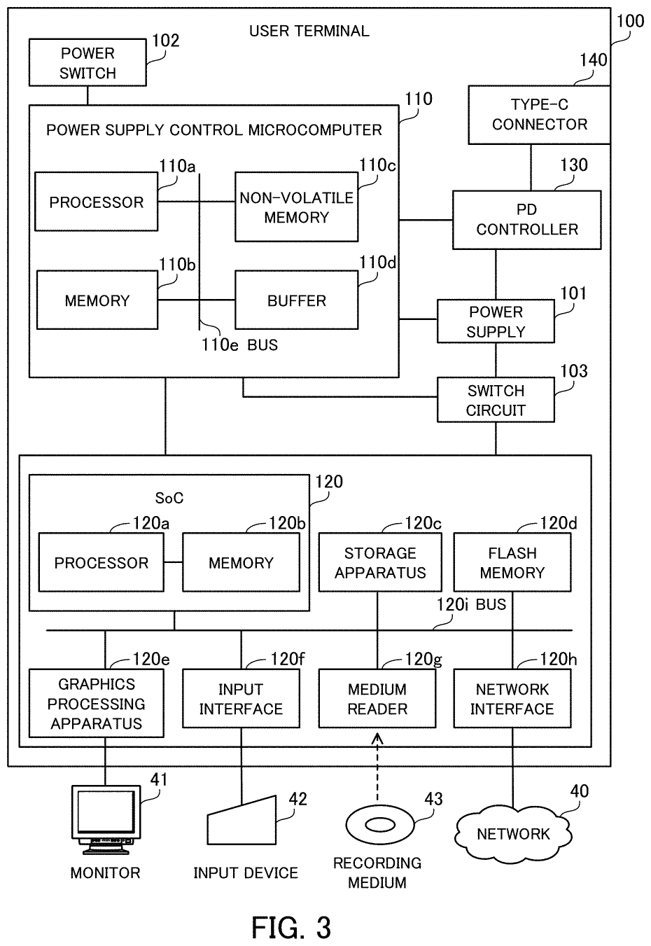

FIG. 3 depicts an example hardware configuration of a user terminal. The user terminal 100 includes a power supply 101, a power switch 102, a switch circuit 103, a power supply control microcomputer 110, a PD (Power Delivery) controller 130, and a Type-C connector 140. The user terminal 100 also has a SoC (System on a Chip) 120 and peripherals that are connected to the SoC 120 via a bus 120i.

The power supply 101 supplies electrical power to the user terminal 100. As examples, the power supply 101 is a battery of the user terminal 100 or commercial power. Note that the power supply 101 may be provided outside the user terminal 100. The power switch 102 is a switch for activating the user terminal 100. The switch circuit 103 is a switch circuit for controlling the electrical power to be supplied to the SoC 120 and the peripherals connected via the bus 120i to the SoC 120. The switch circuit 103 is controlled by the power supply control microcomputer 110.

The power supply control microcomputer 110 is a microcomputer that controls the supplying of power from the power supply 101 to the user terminal 100. The power supply control microcomputer 110 is supplied with electrical power from the power supply 101 even before the power switch 102 is pressed. The supplying of electrical power from the power supply 101 to the power supply control microcomputer 110 is one example of the “first power supplying operation” described in the first embodiment. When the power switch 102 is pressed, the power supply control microcomputer 110 controls the switch circuit 103 so that electrical power is supplied from the power supply 101 to the SoC 120 and to the peripherals connected via the bus 120i to the SoC 120. The supplying of electrical power from the power supply 101 to the SoC 120 is one example of the “second power supplying operation” described in the first embodiment.

Overall control of the power supply control microcomputer 110 is performed by a processor 110a. A memory 110b, a non-volatile memory 110c, and a buffer 110d are connected via a bus 110e to the processor 110a. The processor 110a may be a multiprocessor. As examples, the processor 110a is a CPU (Central Processing Unit), an MPU (Micro Processing Unit), or a DSP (Digital Signal Processor). At least some of the functions realized by the processor 110a executing a program may be realized by an electronic circuit such as an ASIC (Application Specific Integrated Circuit) or a PLD (Programmable Logic Device).

The memory 110b is used as the main storage device of the power supply control microcomputer 110. At least part of an OS program and/or an application program to be executed by the processor 110a is temporarily stored in the memory 110b. Various data used in processing by the processor 110a is also stored in the memory 110b. As one example, a volatile semiconductor storage device such as a RAM (Random Access Memory) is used as the memory 110b.

The non-volatile memory 110c electrically or magnetically writes and reads data onto and from a built-in recording medium. The non-volatile memory 110c is used as an auxiliary storage device of the power supply control microcomputer 110. The non-volatile memory 110c stores the OS program, application programs, and various data. Note that flash memory may be used as an example of the non-volatile memory 110c. The buffer 110d is a buffer for temporarily storing data to be passed to the power supply control microcomputer 110.

The SoC 120 has a processor 120a and a memory 120b. The processor 120a controls the entire user terminal 100. The processor 120a may be a multiprocessor. As examples, the processor 120a is a CPU, an MPU, or a DSP. At least some of the functions realized by the processor 120a executing a program may be realized by an electronic circuit, such as an ASIC or a PLD.

The memory 120b is used as the main storage device of the user terminal 100. At least part of an OS program and/or an application program to be executed by the processor 120a is temporarily stored in the memory 120b. Various data used in processing by the processor 120a is also stored in the memory 120b. As one example, a volatile semiconductor storage device such as RAM is used as the memory 120b.

The peripherals connected to the bus 120i include a storage apparatus 120c, a flash memory 120d, a graphics processing apparatus 120e, an input interface 120f, a medium reader 120g, and a network interface 120h.

The storage apparatus 120c electrically or magnetically writes and reads data onto and from a built-in recording medium. The storage apparatus 120c is used as an auxiliary storage device of the user terminal 100. The OS program, application programs, and various data are stored in the storage apparatus 120c. As examples, an HDD (Hard Disk Drive) and/or an SSD (Solid State Drive) may be used as the storage apparatus 120c.

The flash memory 120d electrically writes and reads data onto and from a built-in recording medium. The BIOS is stored in the flash memory 120d. The BIOS in the flash memory 120d is loaded into the memory 120b and executed by the processor 120a.

A monitor 41 is connected to the graphics processing apparatus 120e. The graphics processing apparatus 120e displays images on the screen of the monitor 41 in accordance with instructions from the processor 120a. Examples of the monitor 41 include a display device that uses organic EL (Electro Luminescence) and a liquid crystal display device.

The input interface 120f acquires an input signal from an input apparatus 42 connected to the user terminal 100 and outputs the input signal to the processor 120a. As examples of the input apparatus 42, a pointing device such as a mouse, a touch panel, a touch pad, or a trackball, a keyboard, a remote controller, and button switches may be used. It is also possible to connect a plurality of types of input apparatus to the user terminal 100.

The medium reader 120g is a reader apparatus that reads programs and data recorded on a recording medium 43. As examples, a magnetic disk, an optical disk, a magneto-optical disk (MO), and a semiconductor memory may be used as the recording medium 43. Magnetic disks include a flexible disk (FD) and an HDD. Optical discs include CDs (Compact Discs) and DVDs (Digital Versatile Discs).

The network interface 120h is connected to a network 40. The network interface 120h transmits and receives data to and from another computer or a communication device via the network 40.

The PD controller 130 controls the supplying of electrical power via the Type-C connector 140. The PD controller 130 is supplied with electrical power from the power supply 101 even before the power switch 102 is pressed. The PD controller 130 controls the supplying of power from the power supply 101 to the debug board 200 via the cable 31 which is connected to the Type-C connector 140. The Type-C connector 140 conforms to USB PD standard.

By using a hardware configuration like that described above, the user terminal 100 realizes the processing functions of the second embodiment. Note that the information processing apparatus 10 described in the first embodiment may also be realized by the same hardware as the user terminal 100 depicted in FIG. 3. Pressing the power switch 102 is one example of the “inputting of a startup instruction” described in the first embodiment. The processor 110a is one example of the second control unit 13 described in the first embodiment. The buffer 110d is one example of the storage unit 12 described in the first embodiment. The processor 120a is one example of the first control unit 11 described in the first embodiment. The Type-C connector 140 is one example of the external output port 14 described in the first embodiment.

As one example, the user terminal 100 realizes the processing functions of the second embodiment by executing a program recorded on a computer-readable recording medium. The program in which the processing content to be executed by the user terminal 100 is written may be recorded on various recording media. As examples, a program to be executed by the user terminal 100 may be stored in the non-volatile memory 110c and/or the storage apparatus 120c. The processor 110a loads at least part of the program in the non-volatile memory 110c into the memory 110b and then executes the program. Likewise, the processor 120a loads at least part of the program in the storage apparatus 120c into the memory 120b and executes the program.

Programs to be executed by the user terminal 100 may also be recorded on the recording medium 43. As one example, a program stored on the recording medium 43 becomes executable after being installed in the non-volatile memory 110c or the storage apparatus 120c under the control of the processor 120a. It is also possible for the processors 110a and 120a to read out and execute programs directly from the recording medium 43.

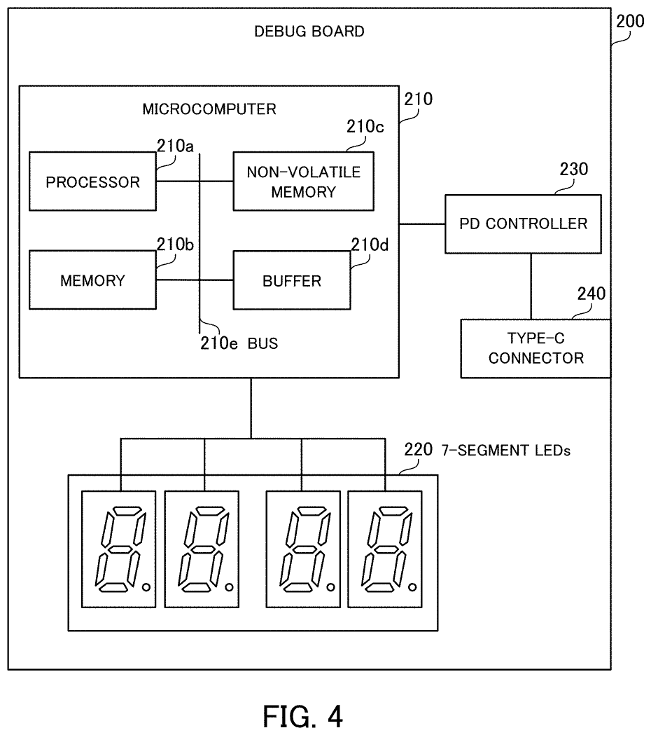

FIG. 4 depicts an example hardware configuration of a debug board. The debug board 200 includes a microcomputer 210, 7-segment LEDs 220, a PD controller 230, and a Type-C connector 240.

The microcomputer 210 performs overall control over the debug board 200. The microcomputer 210 is controlled by a processor 210a. A memory 210b, a non-volatile memory 210c, and a buffer 210d are connected via a bus 210e to the processor 210a. The processor 210a may be a multiprocessor. As examples, the processor 210a is a CPU, an MPU, or a DSP. At least some of the functions realized by the processor 210a executing the program may be realized by an electronic circuit, such as an ASIC or a PLD.

The memory 210b is used as the main storage device of the microcomputer 210. At least part of an OS program and/or an application program to be executed by the processor 210a is temporarily stored in the memory 210b. Various data used in processing by the processor 210a is stored in the memory 210b. As one example, a volatile semiconductor storage device such as RAM is used as the memory 210b.

The non-volatile memory 210c electrically or magnetically writes and reads data onto and from a built-in recording medium. The non-volatile memory 210c is used as an auxiliary storage device of the microcomputer 210. The non-volatile memory 210c stores an OS program, application programs, and various data. Note that flash memory may be used as an example of the non-volatile memory 210c. The buffer 210d is a buffer for temporarily storing data to be passed to the microcomputer 210.

The 7-segment LEDs 220 display one or more alphanumeric characters according to instructions from the processor 210a. The 7-segment LEDs 220 each have seven segments, which are lit when designated by the processor 210a, and each display one alphanumeric character as a combination of lit segments.

The PD controller 230 supplies electrical power, which has been received via the Type-C connector 240, to the entire debug board 200. The Type-C connector 240 conforms to USB PD standard.

By using a hardware configuration like that described above, the debug board 200 realizes the processing functions of the second embodiment. Note that the debug board 20 described in the first embodiment may also be realized by the same hardware as the debug board 200 depicted in FIG. 4. The processor 210a is one example of the processing unit 22 described in the first embodiment. The 7-segment LEDs 220 are one example of the display unit 21 described in the first embodiment.

As one example, the debug board 200 realizes the processing functions of the second embodiment by executing a program recorded on a computer-readable recording medium. The program in which the processing content to be executed by the debug board 200 is written may be recorded on various recording media. As one example, the program to be executed by the debug board 200 may be stored in the non-volatile memory 210c. The processor 210a loads at least part of the program in the non-volatile memory 210c into the memory 210b and executes the program.

The program to be executed by the debug board 200 may also be recorded on a portable recording medium. As one example, a program stored in a portable recording medium connected to another information processing apparatus, such as the user terminal 100, which is connected to the debug board 200 may be installed into the non-volatile memory 210c under the control of the other information processing apparatus so as to become executable. It is also possible for the processor 210a to read and execute the program directly from a portable recording medium.

Next, the Type-C connector 140 will be described.

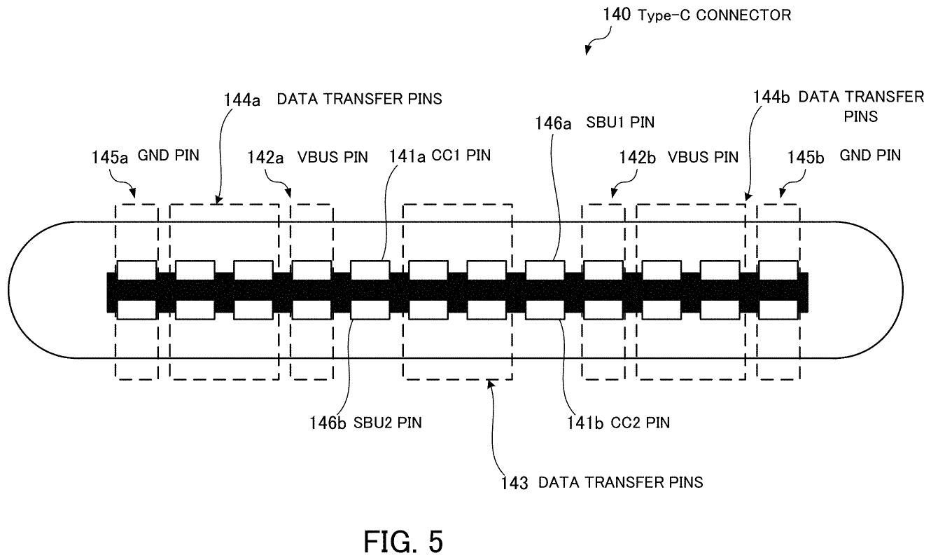

FIG. 5 depicts an example of a connector. The Type-C connector 140 includes a CC (Configuration Channel) 1 pin 141a, a CC2 pin 141b, VBUS pins 142a and 142b, data transfer pins 143, 144a, and 144b, GND (GrouND) pins 145aand 145b, an SBU1 pin 146a, and an SBU2 pin 146b.

Data that enables the PD controller 130 to control the supplying of power from the power supply 101 to the debug board 200 is transmitted from the CC1 pin 141a or the CC2 pin 141b. Note that the transmission of data for controlling the supplying of power by the PD controller 130 is sometimes referred to as “CC communication”. The pin out of the CC1 pin 141a and the CC2 pin 141b that is used for CC communication is determined according to the orientation with which the cable 31 is inserted into the Type-C connector 140. Out of the CC1 pin 141a and the CC2 pin 141b, the pin that is not used for CC communication is used to supply power to the cable 31. In the following description, it is assumed that the CC1 pin 141a is used for CC communication and the CC2 pin 141b is used for supplying power to the cable 31. Note that the PD controller 130 is also capable of transmitting a VDM (Vendor Defined Message) from the CC1 pin 141a.

The VBUS pins 142a and 142b are used to supply power from the power supply 101 to the debug board 200. As one example, the power supply 101 supplies power to the debug board 200 via the VBUS pins 142a and 142b with a current value and/or voltage value decided by the PD controller 130 through CC communication.

The data transfer pins 143, 144a, and 144b are pins used for transferring data. The GND pins 145a and 145b are pins used as GND. The SBU1 pin 146a and SBU2 pin 146b are pins used for transmitting data with protocols that differ to USB Type-C.

Note that the CC1 pin 141a is an example of the control line described in the first embodiment, and the VBUS pins 142a and 142b are examples of the power supply line described in the first embodiment. The Type-C connector 240 also has the same pins as the Type-C connector 140. It is also assumed that the CC1 pin of the Type-C connector 240 is used for CC communication.

Next, the functions of the respective devices included in the information processing system according to the second embodiment will be described in detail.

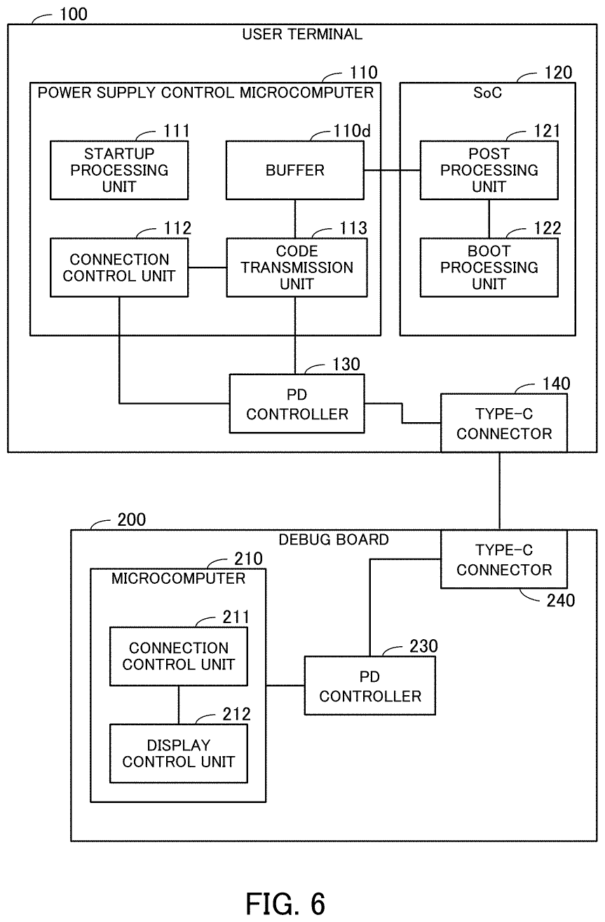

FIG. 6 is a block diagram depicting example functions of a user terminal and a debug board. The power supply control microcomputer 110 of the user terminal 100 includes a startup processing unit 111, a connection control unit 112, and a code transmission unit 113. The startup processing unit 111, the connection control unit 112, and the code transmission unit 113 are realized by the processor 110a executing a program stored in the memory 110b. On detecting a pressing operation of the power switch 102, the startup processing unit 111 controls the switch circuit 103 so that electrical power is supplied from the power supply 101 to the SoC 120.

The connection control unit 112 controls the connection with the debug board 200. As one example, when a device has been connected to the user terminal 100 via the Type-C connector 140, the connection control unit 112 asks the connected device whether the device is a device of a predetermined vendor. When a response indicating that the connected device is a device of the predetermined vendor has been received, the connection control unit 112 asks the connected device about the device type using communication that is stipulated for devices of the predetermined vendor. When a response indicating that the type of the connected device is “debug board” is received, the connection control unit 112 detects that the user terminal 100 and the debug board 200 have been connected.

The code transmission unit 113 has the PD controller 130 transmit the POST code stored in the buffer 110d via the CC1 pin 141a to the debug board 200. As one example, when the connection control unit 112 has detected that the user terminal 100 and the debug board 200 are connected, the code transmission unit 113 has the PD controller 130 transmit the POST code stored in the buffer 110d to the debug board 200. As another example, when the POST code stored in the buffer 110d has been updated, the code transmission unit 113 has the PD controller 130 transmit the POST code stored in the buffer 110d to the debug board 200.

The SoC 120 of the user terminal 100 has a POST processing unit 121 and a boot processing unit 122. The POST processing unit 121 and the boot processing unit 122 are realized by the processor 120a executing the BIOS.

The POST processing unit 121 executes a POST. As examples, the POST executed by the POST processing unit 121 includes verification of whether a device, such as the memory 120b, is normal, detection of devices, and initialization of devices. The POST processing unit 121 also outputs a POST code in keeping with processing to be executed to the buffer 110d. As one example, every time the POST processing unit 121 executes a processing in one step in the POST (or “one step of POST processing”), the POST code stored in the buffer 110d is updated to a POST code corresponding to the processing to be executed.

When the POST executed by the POST processing unit 121 has been completed, the boot processing unit 122 boots the OS. As one example, the boot processing unit 122 specifies a region in the storage apparatus 120c where the OS is stored and loads the OS into the memory 120b.

The microcomputer 210 of the debug board 200 has a connection control unit 211 and a display control unit 212. The connection control unit 211 and the display control unit 212 are realized by the processor 210a executing a program stored in the memory 210b.

The connection control unit 211 controls the connection with the user terminal 100. As one example, when the connection control unit 211 has received a vendor enquiry from the user terminal 100, the connection control unit 211 transmits information indicating that the debug board 200 is a device of a predetermined vendor to the user terminal 100. Also, when an enquiry about the device type has been received from the user terminal 100, as one example, the connection control unit 211 transmits information indicating that the device type of the debug board 200 is “debug board” to the user terminal 100. The display control unit 212 displays the POST code received from the user terminal 100 in hexadecimal on the 7-segment LEDs 220. Note that the lines connecting the respective elements in FIG. 6 are intended to illustrate some of the communication paths, and it is also possible to set other communication paths aside from those that have been illustrated.

Next, the VDM transmitted and received between the user terminal and the debug board will be described.

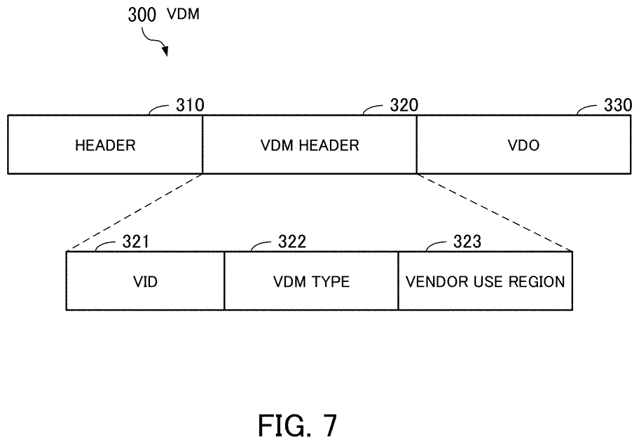

FIG. 7 depicts an example of data transmitted and received between a user terminal and a debug board. The VDM 300 includes a header 310, a VDM header 320, and a VDO (Vendor Data Object) 330. The header 310 is the header of the VDM 300.

The VDM header 320 has a VID (Vendor ID) 321, a VDM type 322, and a vendor use region 323. The VID 321 stores an ID indicating the vendor. The VDM type 322 stores information indicating the type of VDM 300. As one example, the VDM type 322 is one-bit information. When the VDM type 322 is “0”, the VDM300 is a UVDM (Unstructured VDM). When the VDM type 322 is “1”, the VDM 300 is an SVDM (Structured VDM). The vendor use region 323 is a region that the vender is able to set. Data to be transmitted is stored in the VDO 330.

As one example, the code transmission unit 113 transmits the VDM 300 for which the VDM type 322 is “0”, information indicating that the data is a POST code is stored in the vendor use region 323, and a POST code is stored in the VDO 330 to the debug board 200. By doing so, the code transmission unit 113 may transmit a UVDM indicating a POST code to the debug board 200. Note that one example of information indicating that data is a POST code is a write instruction for a predetermined region.

Next, a method by which the user terminal 100 transmits a POST code to the debug board 200 will be described.

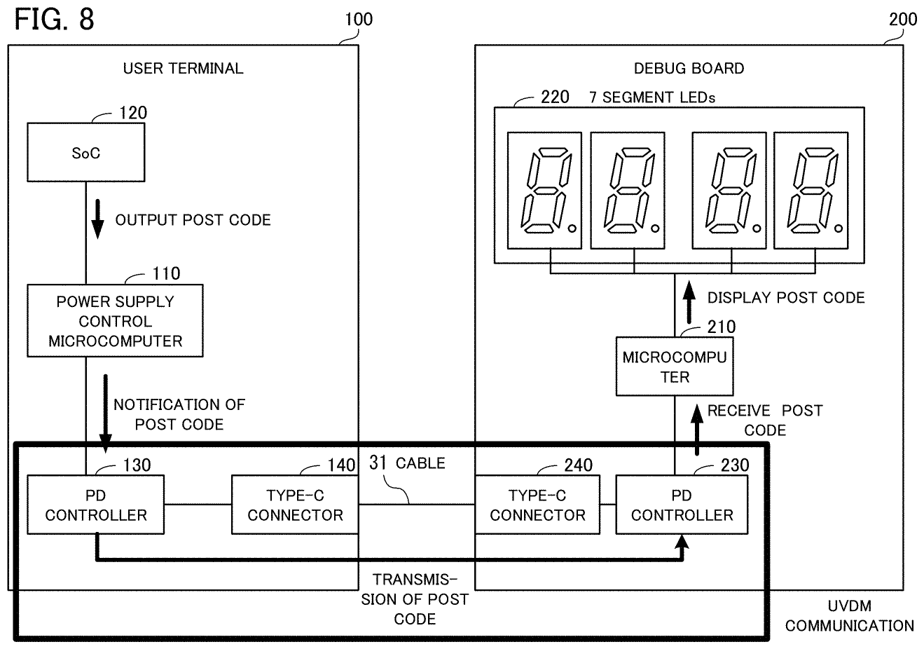

FIG. 8 depicts an example method of transmitting a POST code from a user terminal to a debug board. An example where the debug board 200 displays a POST code in real time while the user terminal 100 is executing a POST is described below.

When executing one step of POST processing, the POST processing unit 121 of the SoC 120 outputs a POST code to the buffer 110d of the power supply control microcomputer 110. As one example, the POST processing unit 121 writes the POST code into the buffer 110d via a bus that conforms to a standard such as eSPI (enhanced Serial Peripheral Interface).

When the POST code stored in the buffer 110d is updated, the code transmission unit 113 of the power supply control microcomputer 110 has the PD controller 130 transmit the POST code. As one example, when the POST code stored in the buffer 110d is updated, the code transmission unit 113 provides the PD controller 130 with a UVDM indicating the POST code via a bus that conforms to a standard such as I²C (registered trademark). The PD controller 130 outputs the UVDM indicating the POST code via the CC1 pin 141a. As a result, the PD controller 230 receives the UVDM via the cable 31 and the CC1 pin of the Type-C connector 240. Note that the transmitting and receiving of a UVDM between the PD controllers 130 and 230 via the CC1 pin is sometimes referred to as “UVDM communication”.

The display control unit 212 of the microcomputer 210 receives the UVDM indicating the POST code from the PD controller 230 via a bus that conforms to a standard such as I²C. The display control unit 212 then has the 7-segment LEDs 220 display the POST code indicated in the UVDM.

In this way, the code transmission unit 113 may transmit the POST code to the debug board 200 using UVDM communication. Since the UVDM communication is performed via the PD controllers 130 and 230, the UVDM communication is executed even when electrical power is not being supplied to the SoC 120. This means that the code transmission unit 113 may transmit the POST code to the debug board 200 regardless of whether electrical power is being supplied to the SoC 120.

As a different method of outputting a POST code to the periphery of a terminal, it would be conceivable to output a UART (Universal Asynchronous Receiver/Transmitter) signal indicating the POST code via a USB Type-A connector. A user terminal for this different method that outputs POST codes using a UART signal is equipped with a component for transferring a UART signal on a line where USB Type-A data signals are transmitted. Compared to this, the code transmission unit 113 of the present configuration outputs a UVDM indicating the POST code from the CC1 pin 141a (for CC communication) which is used to transmit data for controlling the supplying of power. This means that the user terminal 100 may easily transmit a POST code to the debug board 200 using a reduced number of parts.

A USB Type-A connector does not operate when the power supply of a computer main unit is not turned on. This means that the user terminal for the different method described above would not output a POST code when power is not being supplied to the terminal. On the other hand, the code transmission unit 113 of the present configuration may transmit a POST code to the debug board 200 even when electrical power is not being supplied to the SoC 120. This means that the user terminal 100 may transmit a POST code to the debug board 200 even when an abnormality occurred during the POST and the main part of the terminal has shut down.

The procedure of the processing when the user terminal 100 starts up will now be described in detail.

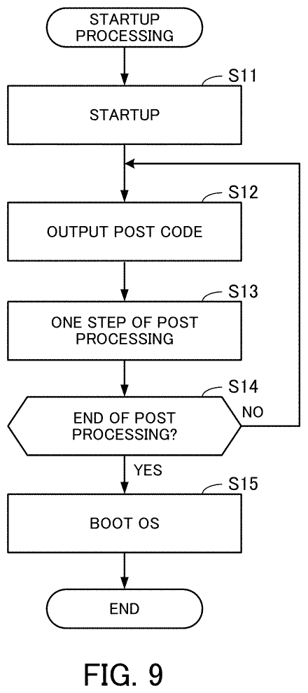

FIG. 9 is a flowchart depicting an example procedure of a startup process. The processing depicted in FIG. 9 will now be described in order of the step numbers.

[Step S11] On detecting a pressing operation of the power switch 102, the startup processing unit 111 controls the switch circuit 103 so that power is supplied from the power supply 101 to the SoC 120 and activates the SoC 120.

[Step S12] The POST processing unit 121 outputs a POST code that corresponds to the processing to be executed next to the buffer 110d. As one example, the POST processing unit 121 updates the POST code stored in the buffer 110d to a POST code that corresponds to the processing to be executed.

[Step S13] The POST processing unit 121 executes the one step of POST processing corresponding to the POST code outputted in step S12. As examples, the one step of POST processing executed by the POST processing unit 121 includes verification that checks whether devices such as the memory 120b are normal, detection of devices, initialization of devices, and the like.

[Step S14] The POST processing unit 121 determines whether the one step of POST processing executed in step S13 is the end of POST processing. When the POST processing unit 121 has determined that the one step of POST processing executed in step S13 is the final processing in the POST, the processing advances to step S15. Conversely, when the POST processing unit 121 has determined that the one step of POST processing executed in step S13 is not the final processing in the POST, the processing returns to step S12.

[Step S15] The boot processing unit 122 boots the OS. As one example, the boot processing unit 122 specifies a region of the storage apparatus 120c where the OS is stored and loads the OS into the memory 120b.

In this way, the POST processing unit 121 executes the POST before the boot processing unit 122 boots the OS. Also, whenever one step of POST processing is completed, the POST processing unit 121 outputs a POST code corresponding to the processing to be executed next to the buffer 110d. This means that when the OS has been booted by the boot processing unit 122, the buffer 110d will store the POST code corresponding to the final processing in a POST. However, when the POST stops midway, the buffer 110d will store a POST code corresponding to the processing that was being executed when the POST stopped.

Next, the procedure of the POST code displaying process performed by the user terminal 100 and the debug board 200 will be described in detail.

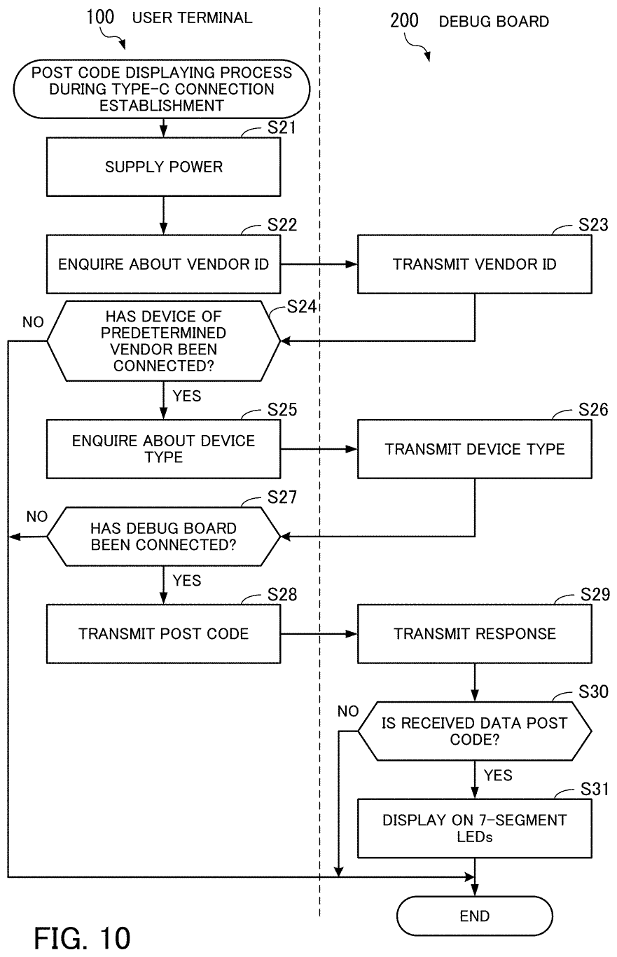

FIG. 10 is a flowchart depicting an example procedure of a POST code displaying process during TYPE-C connection establishment. The process depicting in FIG. 10 will be described in order of the step numbers.

[Step S21] The PD controller 130 of the user terminal 100 causes the power supply 101 to supply electrical power to the debug board 200. As one example, the PD controller 130 decides a current value, voltage value, and the like through CC communication with the PD controller 230 of the debug board 200 via the CC1 pin 141a. The power supply 101 then supplies electrical power with the current value and the voltage value determined by the CC communication to the debug board 200 via the VBUS pins 142a and 142b.

[Step S22] The connection control unit 112 of the user terminal 100 asks the debug board 200 for the vendor ID.

[Step S23] The connection control unit 211 of the debug board 200 transmits information indicating the vendor ID of the debug board 200 to the user terminal 100. As one example, the connection control unit 211 transmits the VDM 300, in which the VID 321 indicates an ID corresponding to a predetermined vendor, to the user terminal 100 using UVDM communication.

[Step S24] The connection control unit 112 determines whether a device of a predetermined vendor has been connected. As one example, when the VID 321 of the VDM 300 received from the debug board 200 in step S23 indicates the ID of a predetermined vendor, the connection control unit 112 determines that a device of the predetermined vendor has been connected. When the connection control unit 112 has determined that a device of the predetermined vendor is connected, the processing proceeds to step S25. Conversely, when the connection control unit 112 has determined that a device of a different vendor to the predetermined vendor has been connected, the connection control unit 112 ends the processing.

[Step S25] The connection control unit 112 asks the debug board 200 about the device type. As one example, the connection control unit 112 asks the debug board 200 about the device type using a communication method that is stipulated for devices of a predetermined vendor.

[Step S26] The connection control unit 211 transmits the device type of the debug board 200 to the user terminal 100. As one example, the connection control unit 211 transmits the VDM 300, which has information indicating that the device type is a debug board stored in the vendor use region 323, to the user terminal 100 using UVDM communication. Note that the VDM 300 transmitted by the connection control unit 211 in steps S23 and S26 is one example of the information indicating that the information processing apparatus 10 and the debug board 20 have been connected that was described in the first embodiment.

[Step S27] The connection control unit 112 determines whether a debug board has been connected. As one example, the connection control unit 112 determines that a debug board is connected when information indicating that the device type is a debug board is stored in the vendor use region 323 of the VDM 300 received from the debug board 200 in step S26. When the connection control unit 112 has determined that a debug board has been connected, the processing proceeds to step S28. Conversely, when the connection control unit 112 has determined that a debug board has not been connected, the processing ends.

[Step S28] The code transmission unit 113 of the user terminal 100 transmits the POST code stored in the buffer 110d to the debug board 200. As one example, the code transmission unit 113 transmits the VDM 300, which has information indicating that the data is a POST code stored in the vendor use region 323 and information indicating the POST code stored in the buffer 110d in the VDO 330, to the debug board 200 using UVDM communication.

[Step S29] The connection control unit 211 transmits a response indicating that data has been received to the user terminal 100.

[Step S30] The display control unit 212 of the debug board 200 determines whether the data received from the user terminal 100 is a POST code. As one example, when information indicating that the data is a POST code is stored in the vendor use region 323 of the VDM 300 received from the user terminal 100 in step S28, the display control unit 212 determines that the received data is a POST code. When the display control unit 212 has determined that the received data is a POST code, the processing proceeds to step S31. Conversely, when the display control unit 212 has determined that the received data is not a POST code, the processing ends.

[Step S31] The display control unit 212 displays the POST code in hexadecimal on the 7-segment LEDs 220. As one example, the display control unit 212 reads the POST code stored in the VDO 330 of the VDM 300 received from the user terminal 100 in step S28. The display control unit 212 then displays the read POST code in hexadecimal on the 7-segment LEDs 220.

In this way, when the user terminal 100 and the debug board 200 have been connected, the code transmission unit 113 transmits the POST code to the debug board 200 using UVDM communication. The display control unit 212 then has the 7-segment LEDs 220 display the POST code received from the user terminal 100. By doing so, the display control unit 212 notifies the user of the POST code indicating the final process that was executed during the previous POST performed by the user terminal 100.

As one example, when the previous POST by the user terminal 100 completed normally, the display control unit 212 has the 7-segment LEDs 220 display the POST code corresponding to the final processing in a POST. As another example, when the previous POST by the user terminal 100 ended midway, the display control unit 212 has the 7-segment LEDs 220 display the POST code corresponding to the processing that was being executed when the POST stopped. In this way, the display control unit 212 notifies the user whether there was an abnormality during the previous POST by the user terminal 100.

By using UVDM communication, the code transmission unit 113 may transmit the POST code to the debug board 200 even when electrical power is not being supplied to the SoC 120. This means that even when a POST by the user terminal 100 ends midway and the supplying of power to the SoC 120 has stopped, the code transmission unit 113 may transmit a POST code to the debug board 200 in response to the user terminal 100 and the debug board 200 being connected. The display control unit 212 may then notify the user of the processing where an abnormality occurred during a POST by displaying the received POST code on the 7-segment LEDs 220.

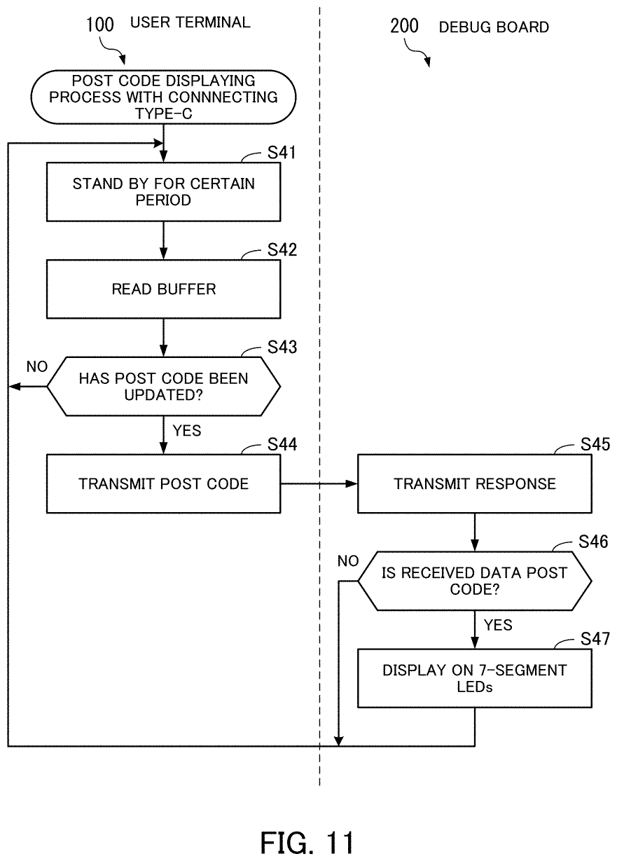

FIG. 11 is a flowchart depicting an example procedure of a POST code displaying process with connecting TYPE-C. As one example, the mid-connection POST code displaying process depicted in FIG. 11 is executed during execution of the startup process depicted in FIG. 9 after the connection-establishment POST code displaying process depicted in FIG. 10. The processing depicted in FIG. 11 will now be described in order of the step numbers.

[Step S41] The code transmission unit 113 of the user terminal 100 stands by for a certain period.

[Step S42] The code transmission unit 113 reads the POST code from the buffer 110d.

[Step S43] The code transmission unit 113 determines whether the POST code stored in the buffer 110d has been updated. As one example, when the POST code read in step S42 differs to the POST code read from the buffer 110d the previous time, the code transmission unit 113 determines that the POST code stored in the buffer 110d has been updated. When the code transmission unit 113 determines that the POST code stored in the buffer 110d has been updated, the processing proceeds to step S44. Conversely, when the code transmission unit 113 determines that the POST code stored in the buffer 110d has not been updated, the processing returns to step S41.

[Step S44] The code transmission unit 113 transmits the POST code read from the buffer 110d in step S42 to the debug board 200.

[Step S45] The connection control unit 211 transmits a response indicating that data has been received to the user terminal 100.

[Step S46] The display control unit 212 of the debug board 200 determines whether the data received from the user terminal 100 is a POST code. When the display control unit 212 has determined that the received data is a POST code, the processing proceeds to step S47. Conversely, when the display control unit 212 has determined that the received data is not a POST code, the processing returns to step S41.

[Step S47] The display control unit 212 has the POST code displayed in hexadecimal on the 7-segment LEDs 220. The processing then returns to step S41.

In this way, when the POST code stored in the buffer 110d has been updated, the code transmission unit 113 transmits the POST code to the debug board 200 using UVDM communication. The display control unit 212 then has the 7-segment LEDs 220 display the POST code received from the user terminal 100. By doing so, the display control unit 212 provides the user with a POST code indicating which process is being executed in the POST processing in real time. By using UVDM communication, the code transmission unit 113 may transmit a POST code to the debug board 200 even when a POST by the user terminal 100 ends midway and the supplying of electrical power to the SoC 120 has stopped.

With the information processing system according to the second embodiment, when the power switch 102 is pressed, the POST processing unit 121 of the SoC 120 that is supplied with electrical power from the power supply 101 executes the POST processing and a POST code indicating the execution step of the processing is outputted to the buffer 110d. The code transmission unit 113 of the power supply control microcomputer 110 that is supplied with electrical power from the power supply 101 regardless of whether the power switch 102 has been pressed is capable of outputting the POST code stored in the buffer 110d from the Type-C connector 140. The display control unit 212 of the debug board 200 then received the POST code and displays the POST code on the 7-segment LEDs 220. By doing so, the information processing system according to the second embodiment enables the user to confirm the POST code even when the SoC 120 has not started up. This means that the information processing system according to the second embodiment may easily notify the user of an abnormality.

The Type-C connector 140 includes the VBUS pins 142a and 142b for supplying electrical power from the power supply 101 to the debug board 200 and the CC1 pin 141a that outputs data for controlling the supplying of power from the power supply 101 to the debug board 200. The code transmission unit 113 is capable of outputting the POST code stored in the buffer 110d from the CC1 pin 141a. In this way, since the code is transmitted from a power supply control line, the user terminal 100 may easily transmit the POST code to the debug board 200 using a reduced number of components.

When the user terminal 100 and the debug board 200 are connected via the Type-C connector 140, the connection control unit 211 transmits information indicating that the user terminal 100 and the debug board 200 have been connected to the user terminal 100. When the information indicating that the user terminal 100 and the debug board 200 have been connected has been received, the code transmission unit 113 outputs the POST code stored in the buffer 110d from the Type-C connector 140. By using this configuration, with the information processing system according to the second embodiment, by connecting the user terminal 100 and the debug board 200, it is possible for the user to confirm a POST code indicating the final process of the POST processing performed the last time.

The code transmitting unit 113 is capable of outputting the POST code stored in the buffer 110d from the Type-C connector 140 even after the power switch 102 has been pressed. By doing so, the information processing system according to the second embodiment enables the user to confirm a code indicating the execution step in a POST even when the SoC 120 has started up.

When the POST code stored in the buffer 110d is updated during execution of the POST processing by the user terminal 100, the code transmission unit 113 outputs the POST code stored in the buffer 110d from the Type-C connector 140. By doing so, the information processing system according to the second embodiment may notify the user of the occurrence of an abnormality in real time during execution of the POST processing by the user terminal 100.

According to the present embodiments, it is possible to easily notify a user of an abnormality.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing system comprising:
an information processing apparatus including a memory that is supplied with electrical power from a power supply by a first power supplying operation, a first processor that is supplied with electrical power from the power supply by a second power supplying operation that is started in response to inputting of a startup instruction during execution of the first power supplying operation, that executes a series of processes that precedes booting of an operating system, and that outputs a code indicating an execution step in the series of processes to the memory, and a second processor that is supplied with electrical power from the power supply by the first power supplying operation and is capable of outputting the code stored in the memory from an external output port at least while the first power supplying operation is being performed before the inputting of the startup instruction; and
a debug board including a display unit and a third processor that receives the code from the external output port and displays information based on the code on the display unit.

2. The information processing system according to claim 1,
wherein the external output port includes a power supply line for supplying electrical power from the power supply to the debug board while the first power supplying operation is being performed and a control line on which data for controlling supplying of power from the power supply to the debug board is outputted, and
the second processor is capable of outputting the code stored in the memory from the control line.

3. The information processing system according to claim 1,
wherein the third processor is operable, in response to the information processing apparatus and the debug board being connected via the external output port, to transmit information indicating that the information processing apparatus and the debug board have been connected to the information processing apparatus, and
the second processor is operable, upon receiving the information indicating that the information processing apparatus and the debug board have been connected, to output the code stored in the memory from the external output port.

4. The information processing system according to claim 1,
wherein the second processor is capable of outputting the code stored in the memory from the external output port while the first power supplying operation is being executed after the inputting of the startup instruction.

5. The information processing system according to claim 4,
wherein, at execution of one step of processing in the series of processes, the first processor updates the code stored in the memory to a code corresponding to the one step of processing, and
the second processor outputs, in response to the code stored in the memory being updated during execution of the series of processes by the first processor, the code stored in the memory from the external output port.

6. An information processing apparatus comprising:
a memory that is supplied with electrical power from a power supply by a first power supplying operation;
a first processor that is supplied with electrical power from the power supply by a second power supplying operation that is started in response to inputting of a startup instruction during execution of the first power supplying operation, that executes a series of processes that precedes booting of an operating system, and that outputs a code indicating an execution step in the series of processes to the memory; and
a second processor that is supplied with electrical power from the power supply by the first power supplying operation and is capable of outputting, at least while the first power supplying operation is being performed before the inputting of the startup instruction, the code stored in the memory from an external output port to a debug board that displays information based on the code.

7. A non-transitory computer-readable recording medium storing therein a computer program that causes a second processor of a computer, which includes a memory that is supplied with electrical power from a power supply by a first power supplying operation, a first processor that is supplied with electrical power from the power supply by a second power supplying operation that is started in response to inputting of a startup instruction during execution of the first power supplying operation, that executes a series of processes that precedes booting of an operating system, and that outputs a code indicating an execution step in the series of processes to the memory, and the second processor that is supplied with electrical power from the power supply by the first power supplying operation, to execute a process comprising:
outputting, while the first power supplying operation is being performed before the inputting of the startup instruction, the code stored in the memory from an external output port to a debug board that displays information based on the code.
